(19) United States
(12) Patent Application Publication
(10) Pub. No.: US 2022/0136482 A1
(43) Pub. Date: May 5, 2022

(54) Improvements to a helical fan/pump/propeeler/trubine

(71) Applicant: Grace COULTER, Taupo (NZ)

(72) Inventor: Grace COULTER, Taupo (NZ)

(21) Appl. No.: 17/428,290

(22) PCT Filed: Feb. 8, 2020
(86) PCT No.: PCT/NZ2020/050008

§ 371 Date: Aug. 4, 2021

(30) Foreign Application Priority Data
Feb. 8, 2019 (NZ) 750546
Apr. 5, 2019 (NZ) 752445
Jun. 4, 2019 (NZ) 754159
Oct. 17, 2019 (NZ) 758314
Nov. 11, 2019 (NZ) 759039

(51) Int. Cl. F03D 1/06

(52) U.S. Cl. CPC F03D 1/0625; F05B 2250/25; F05B 2260/20; F05B 2240/30

(57) ABSTRACT

The present invention relates to improving the efficiency of a helical fan/pump/propeller/turbine such as is described in PCT/NZ2018/050010. Further to the discovery that specific longitudinal limits are critical to define the first opening in relation to the helical fan/pump/propeller/turbine, it was found that certain lateral limits are also critical. Thus the configuration of the first opening and the helical blade cooperate according to both longitudinal and lateral limits to improve results. This was found to be the case in many applications whether the rotor is mechanically rotated or rotated by an external energy such as wind. In fact, common features such as this can enable the invention to switch between applications in some cases. The present invention also relates to a second opening longitudinally offset from the intake opening and an elongate stator extending from the rotor that is shaped according to the desired flow path

This application is based on the Provisional specification filed in relation to New Zealand Patent Application Numbers 750546, 752445, 754159, 758314 and 759039, the entire contents of which are incorporated herein by reference.

### FIELD OF INVENTION

The present invention relates to improving efficiency in a helical fan/pump/propeller/turbine such as is described in PCT/NZ2018/050010 according to the desired flow path in various applications.

### BACKGROUND TO THE INVENTION

The fan, turbine, propeller or pump of patent PCT/NZ2018/050010 describes a helical blade that draws in a fluid from a side of an axis and deflects this to an exhaust opening that is longitudinally offset from the intake opening. The described rotor comprises one or more blades having a root substantially helically shaped to the longitudinal axis wherein the tangent to the blade approaches perpendicular alignment to the axis at the origin of a first end portion and at a first longitudinal limit of the intake opening, and approaches parallel alignment to the axis at a second end of the first end portion and a second longitudinal limit of intake opening.

Subsequent tests have discovered that efficiency of the helical fan/pump/propeller/turbine is not only influenced by the length of the intake opening along the longitudinal axis but also its arc length around the circumference. In fact, it was found that the surface area of the housing in the first portion needs to be at least a fifth of the total surface area of the cylinder in the first portion, and that the lateral limits also depend on longitudinal limits to prevent losses which tend to increase towards the end of the first portion. Thus the configuration of the inlet in the housing and the blade cooperate according to both longitudinal and lateral limits to improve volume and pressure. This can be the case in all applications of fan/pump/propeller/turbine whether mechanically driven or driven from an external force like wind.

More tests revealed that the housing could be set back from the origin of the blade only along an initial portion of the first end portion without losses. Therefore, in applications where fluid can be drawn in from all sides and in order to achieve maximum efficiency, an intake opening can be stepped or shaped accordingly.

Two optional designs of stator and rotor were tested. In the first option, the blade overlaps longitudinally with the stator in the third portion and is detached from it. The second opening is substantially aligned with the stator and the end portion of the blade. In the second option in contrast, the blade finishes at the end of a second portion and the stator is shaped differently in order to divert fluid to the exhaust opening.

It was found that the first option provided more pressure and volume than the second option, but also consumed more power. Whether or not the blade extends into the third portion and longitudinally overlaps with the stator may depend on the application according to requirements.

In the current invention, the rotor and stator, which may in many cases be stationary, can enhance its versatility to direct fluid flow, thereby broadening the range of useful applications. The objective is to improve certain features to increase flow rate and pressure and/or reduce torque, noise level and/or power consumption in applications such as a fan, pump or propeller.

Unlike a standard cross flow fan for example, where the intake is at about 270 degrees longitudinally offset from the outlet, there is significant versatility of application when an intake opening is not restricted to a particular side or sides in relation to the exhaust opening. This is demonstrated in the various applications from a heater to a pump to a vertical axis wind turbine. Test results show little difference when the outlet opening is changed in relation to the intake. This is not the case with the standard cross flow fan.

The stator in the third portion also contributes to its versatility. It can smoothly direct fluid without contributing to its torque and hence minimize power consumption. The design of the stator depends on, for example, the location or locations of the exhaust openings or the choice of the two options as already mentioned.

In the first option, the stator conforms to the contour of the blade as it rotates in the third end portion. In the second option in contrast, the stator is shaped independently of the blade in order to smoothly direct air to the opening by means of one or more saddles connecting the center of the stator that supports the axis to one or more locations at the outer wall of the stator opposite one or more openings. The stator progressively increases in cross sectional area around the center and inside the periphery of the stator opposite the opening from the third longitudinal limit to the fourth longitudinal limit of the third portion. The rate of growth of the cross-sectional area of the stator affects the rate of the acute angle of the stator as it progresses along the longitudinal axis towards the fourth longitudinal limit of the third portion, and therefore the angle of delivery of fluid out the second opening. The stator can comprise one or more concave channels to contribute to smoothly delivering a fluid.

The objective of the current patent is also to improve the performance of a turbine for use as a wind or tidal turbine by using an improved rotor, directional vane design, means of increasing the torque and rpm and a means of smoothly channeling and, in some cases, capturing the fluid. Most designed turbines scatter wind making it difficult to capture air for the purposes of removal of carbon for example. It is also the objective of the current patent to reduce the cut-in speed. Small wind turbines require about a minimum wind speed of 4 meters per second, but by optimizing the design, this cut-in speed can be reduced and the amount of air captured increased.

The current patent uses a streamline rotor described in PCT/NZ2018/050010 which replicates the spiraling motion in nature, in conjunction with a stator to direct the air flow according to the desired direction of flow path. As described in PCT/NZ2018/050010, it is preferable that the blade is shaped according to a logarithmic or similar helix but in some cases a regular helix will also be suitable.

The design of the rotor is ideally suited to minimize drag due to its separated flow path for exhausted air above and/or below the rotor. The stationary stator on each side of the rotor can direct air to one, some or all sides of the axis longitudinally offset from the intake. One application for this is the processing of exhausted air for carbon capture using filters around the large periphery in areas between stacked VWATs that can comprise a tower. It is important especially in an urban context to control the exhausted wind energy. Instead of, or in addition to a filter, the cavity may comprise a means to remove water from the air.

In an application as a water turbine in a river for example, it can incorporate a stator that smoothly channels water to one or both sides of the axis. This may collect weed or plastic debris for later collection. These are some of many uses given the rotor and stator's capacity to divert a fluid to one place.

One of the objectives of the VWAT is to control the flow path to remove carbon in the air in dirty cities. We are told the next 10 years is the final window of opportunity to avert climate catastrophe due to global warming and carbon emissions, and yet each year's CO2 emission is higher than the last. Ideally, carbon dioxide is captured near its emission source. Cities around the world that are blanketed by black carbon and dust could use the technology of the current patent to clean air. If the current patent is to be multi-functional for this purpose and to generate energy, it will be important for the VAWT to be undisruptive to residents when placed within communities due to aesthetic design & low noise volume.

According to naturalist Jay Harman, all motion is spiral. This is the archetypal shape of nature. The efficiency of devices like rotors could be significantly improved by reconfiguring them according to the shapes of nature. The current patent replicates the spiraling motion in nature. A stator can continue to smoothly direct the air flow according to the desired direction of flow path. Tests showed that the stator contributed to the efficiency of the rotor. It adds little to torque or energy input but increases efficiency.

Despite the many similarities between a fan or pump and a turbine driven by an external force like wind or waves, there are also some critical differences too. Firstly the direction of rotation is the opposite. Also, the objective with a fan or pump is to minimize torque in order to reduce power consumption, whereas the objective with a vertical axis wind turbine for example, is to increase torque in order to generate more power. One very effective means to increase torque is to include baffles along the concave blade. In cases where the blade is shaped according to logarithmic or similar sequencing, this is particularly effective in the earlier portion where the blade approaches perpendicular alignment with the axis. Air can still be allowed to pass through if a gap is included between the baffle and the concave surface of the blade. If the baffle is also curved in the direction of the blade, then air can more easily pass above and below for the purposes of capturing air, while also creating torque. If baffles are not included or if they are removable, the VWAT can switch to a fan to continue to remove carbon from the air when the wind speed is low.

A greater torque can also be achieved by capturing most of the wind energy at the outer periphery of the VWAT. For this reason, a concave blade can be detached from the axis leaving a relatively large gap between the axis and the blade. In this way, more force can be exerted at the periphery of the VWAT. In this case, the stator on one or both sides of the rotor may not serve to direct air to the sides of the axis longitudinally offset from the intake. Instead, an inner wall in the third portion for example, can encourage air to flow to one or both ends of the VWAT.

Another important consideration is to minimize drag. In cases where the blade is shaped according to logarithmic or similar sequencing, this can be achieved by means of concave blades especially in the second portion where it approaches parallel alignment with the axis. Also, air is able to be more smoothly diverted to one or both sides where the blade approaches perpendicular alignment with the axis thereby further reducing drag.

In the case of the design, simulation and testing of a vertical axis wind turbine with the omni-direction-guide-vane (ODGV) by Chong, W. T. Fazlizan, A. Poh, S. C. Pan, K. C. Hew, W. P. Hsiao, F. B. it was revealed that the ODGV integrated wind power generation system improves the power output of a VAWT and has great potential to be sited in urban areas for on-site and grid-connected power generation.

ODGV are not new and have been used to funnel air towards one side of the turbine in order to cause a vortex of air movement thereby rotating the turbine and preventing drag on its other side. This helps to reduce the cut-in speed, increase the rate of rotations due to increased and directional flow. In addition, the ODGV incorporates concave and convex horizontal vanes which further widen the wind catchment area in order to significantly reduce cut-in wind speed, and increase rate of rpm and torque. Although it was found through tests that the above is true, it was also found that the turbulence energy and the negative pressure downwind of the VWAT caused some proportion of air to be pulled back out the ODGV without being usefully used to drive the VWAT

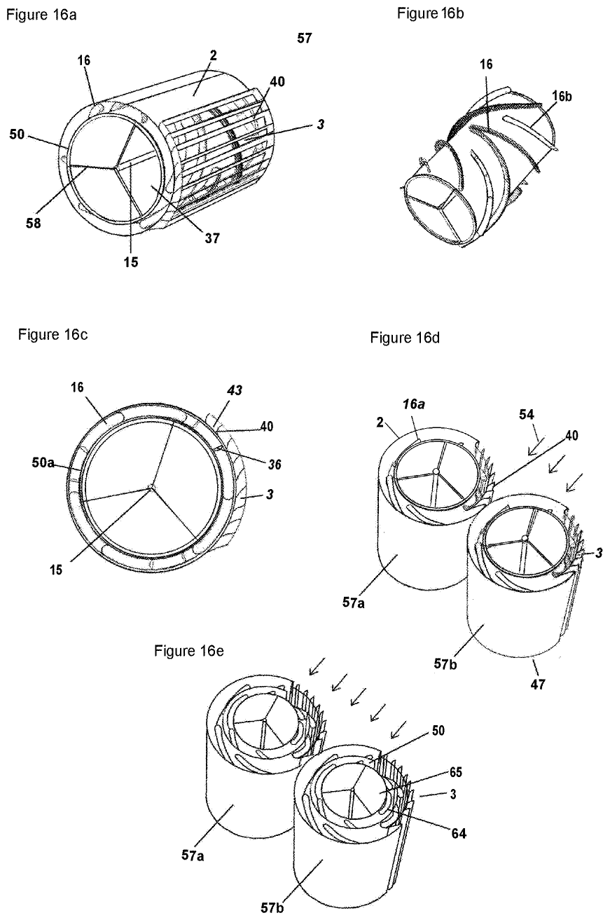

Another embodiment of VWAT described in FIG. 16 produced significantly better results. This embodiment has a larger gap between the blades and the axis; the blades are located on the outside periphery without dependence on ODGV. There is also an inner cylindrical wall along the inside edge of the blades that directs air to either one side or the other of the inner wall depending on the location of the opening in the housing and the direction of wind. A relatively narrow opening in the housing orientated substantially at an acute angle to the wind such that wind drives one side only of the blades produced good results. Since wind direction changes, optimum results can be achieved by either rotating the housing, built-in vents in the housing that open or close, or other means for the VWAT to respond to the wind direction.

The essential goal of the VAWT design is as follows:
Co-location of renewable energy generation and storage to provide 24/7 energy at a community or industrial scale (battery storage at base)
Quiet and efficient VAWTs suitable for use at close proximity to residential areas
Stackable design to optimise space & efficiency within communities
Continuous operation even when the wind direction changes
A very low cut-in speed (i.e. the wind speed when the blades start turning)
A reduction in the intermittent availability of renewable energy by combining PV and wind energy.
Carbon capture to remove carbon dioxide and black carbon from the atmosphere

Large areas of filtration between stacked VAWTs can be provided to lessen the frequency of maintenance. Preferably the filters are robust and washable. A tower of stacked VWATs can be spatially compact with all-in-one multi-functionality from battery storage, carbon removal, water collection and stackable electricity generators from a mix of wind and solar. This would have a distinctive appearance such that it could become a landmark to notify motorists of a dock charging facility for example.

Situating wind turbines in an urban environment will generally give lower wind speeds due to the influence of wind shelters e.g. buildings. For this reason, it is important that the rotor design facilitates movement at minimum air speeds. If there is little wind at lower levels of stacks of rotors (1), some of the stacked VWATs can incorporate mechanically driven rotors for the purposes of carbon capture.

Some possible future uses of the stacked VWATS range from:
Dock charging for electric cars. Locations could include: top of car park building, side of the road, shopping malls, schools, hospitals, aged care facilities and
A battery for the community. Residents with solar power could feed into local tower batteries saving the need for an expensive home battery or low returns when feeding directly into the grid. Power stored in the tower could feed back to the community during peak power use.
A means of mitigating pollution through carbon capture. If carbon capture is a priority and there is insufficient wind in that area, then the rotors can be mechanically operated using solar to run the rotors.
A shelter belt on farms or orchards or by the sea where there is an abundance of wind.
Dock charging and carbon capture at airports which are often windy places. If aeroplanes become electric in the future, then these towers would play a useful part in providing renewable energy.
Advertising on the panels between the VWATs in order to increase revenue for the VWATs

One or more stacked VWATs (forming a tower) could pay for themselves in energy at the same time as providing a way to clean the environment and contribute to offsetting carbon emissions. The panels between the VAWTs, part of the vertical and convex directional vanes on the solar side and the roof can incorporate flexible PV while the non-solar side could be used for advertising. Ideally these towers would become a source of income as well as benefiting the urban environment.

### DISCLOSURE OF THE INVENTION

According to one aspect of the invention there is provided a rotor rotatable, the rotor comprising an elongate first portion having a longitudinal axis and at least one pair of blades, wherein at least one blade extends from the first end portion, the blade having a root which is substantially helically shaped to the longitudinal axis with a flat and/or concave pressure face;

Preferably a first opening defines the fluid intake provided substantially axially aligned with the substantially helically shaped first portion;

Preferably a second opening defines a fluid outlet longitudinally offset from the first opening,

Preferably the first opening is defined by one or more first and second lateral limits around the circumference of housing and their corresponding longitudinal limits between a first end of the housing and the second longitudinal limit of the first end portion;

Preferably the surface area of housing between lateral and longitudinal coordinates amounts to at least a fifth of the total surface area of the housing and the first opening between the first end of the housing and the second longitudinal limit

According to a second aspect of the invention, the root in the first portion is substantially helically shaped to the longitudinal axis according to a logarithmic, exponential, power or other sequencing such that the tangent to the blade approaches perpendicular alignment to the axis at a first end of the first end portion, and a first end of the first opening, and approaches parallel alignment to the axis at a second longitudinal limit of the first end portion, and a longitudinal limit of the first opening.

According to a third aspect of the invention, preferably a third end portion comprises the second opening defining the fluid outlet provided substantially axially aligned with a third substantially helically shaped portion and an elongate stator;

Preferably the second opening extends from a first longitudinal limit to a fourth longitudinal limit of the third end portion and from a third lateral limit to a fourth lateral limit around the circumference of the housing;

Preferably the elongate stator directs the flow path towards the second opening at an acute and/or right angle to the longitudinal axis;

Preferably a second substantially helically shaped portion is enclosed by housing.

According to a fourth aspect of the invention, the elongate stator preferably cooperates with the inner and outer edges of the blade as it rotates in third end portion;

Preferably the diameter of the blade decreases and the cross-sectional area of elongate stator increases from the third longitudinal limit to the fourth longitudinal limit.

According to a fifth aspect of the invention, one or more saddles preferably connect the centre of the elongate stator that supports the axis to the outer periphery of the elongate stator opposite one or more second openings;

Preferably the elongate stator increases in cross-sectional area from the third longitudinal limit to the fourth longitudinal limit;

Preferably the elongate stator comprises concave channels on either side(s) of one or more saddles to direct flow at an increasingly acute angle along the longitudinal axis towards the fourth longitudinal limit of the third end portion.

According to a sixth aspect of the invention, the first lateral limit is preferably the same as the second lateral limit to form a first opening around the entire circumference in a first portion of the first end portion;

Preferably the surface area of the housing between lateral and longitudinal coordinates and between the first end of the housing and the second longitudinal limit of the first end portion amounts to at least a fifth of the total surface area of housing and first opening between the first end of the housing and the second longitudinal limit in a second portion of the first portion between lateral and longitudinal coordinates and between the first end of the housing and the second longitudinal limit of the first end portion;

Preferably the third end portion comprises vanes longitudinally aligned with the second opening and the elongate stator; and/or directional vents at the second opening.

According to a seventh aspect of the invention, the diameter of the housing preferably reduces and the cross-sectional area of the elongate stator preferably increases from the third longitudinal limit to the fourth longitudinal limit in the third end portion;

Preferably the rate of the cross-sectional area increases along the elongate stator (11)

According to an eighth aspect of the invention, the device comprises one or more rotors of opposite chirality rotatable by one or more motors;

Preferably one or more portions of housing rotate independently of rotor or duct positioned on one or more opposite sides of the housing such that the first opening and the second opening are interchangeable to supply or exhaust fluid;

Preferably the device also comprises heat exchange components between the rotor and the second interior vent.

According to a ninth aspect of the invention, the device comprises two or more co-axial rotors;

Preferably the co-axial rotors comprise a means to invert rotational direction of the two or more co-axial rotors;

Preferably the means comprises bevel gears.

According to a tenth aspect of the invention, the device comprises a rotor comprising an elongate first and second substantially helically shaped first portions having a longitudinal axis, the second helically shaped first portion having an opposite chirality to the first substantially helically shaped first portion Preferably there are at least two pairs of blades, wherein at least one first and one second blade extend from the elongate first and second substantially helically shaped first portions;

Preferably the first opening defining the fluid intake substantially axially aligns with first end portions of the first and second substantially helically shaped first portions;

Preferably at least two second openings define a fluid outlet longitudinally offset from the first opening;

Preferably at least two third end portions comprising the second opening define a fluid outlet longitudinally offset from the first opening.

According to an eleventh aspect of the invention, the first opening defines the fluid intake provided substantially axially aligned with the substantially helically shaped first and second portions;

Preferably the surface area of housing between the lateral limits amounts to at least a fifth of the total surface area of the first and second end portions of the housing and the first opening;

Preferably the blade is rotated by an external energy such as wind or water Preferably the blade comprises one or more baffles in one or more blades wherein blade is concave;

Preferably there is a gap between one or more baffles and the surface of the blade;

Preferably the one or more baffles are longitudinally concave in the direction of the blade

According to a twelfth aspect of the invention, the device comprises an inner cylindrical wall between the blade and the axis;

Preferably the third end portion comprises a cavity and a means to capture a fluid Preferably a side of the first opening directs a fluid counter to the direction of the blade rotation to create a vortex between the housing and the blade.

Preferably omni-directional guide vanes (ODGV) radiate partially or totally around the turbine;

According to a thirteenth aspect of the invention, the first and second substantially helically shaped first portions and a first and second substantially helically shaped second portions direct a fluid towards the central portion between the first and second substantially helically shaped first portions;

Preferably the inner cylindrical wall comprises a gap in the central portion

According to a fourteenth aspect of the invention, the device comprises one or more venturi tubes in the walls of the cavity of the third end portion to collect condensate Preferably the one or more venturi tube housing(s) are hexagonal

### DESCRIPTION OF THE INVENTION

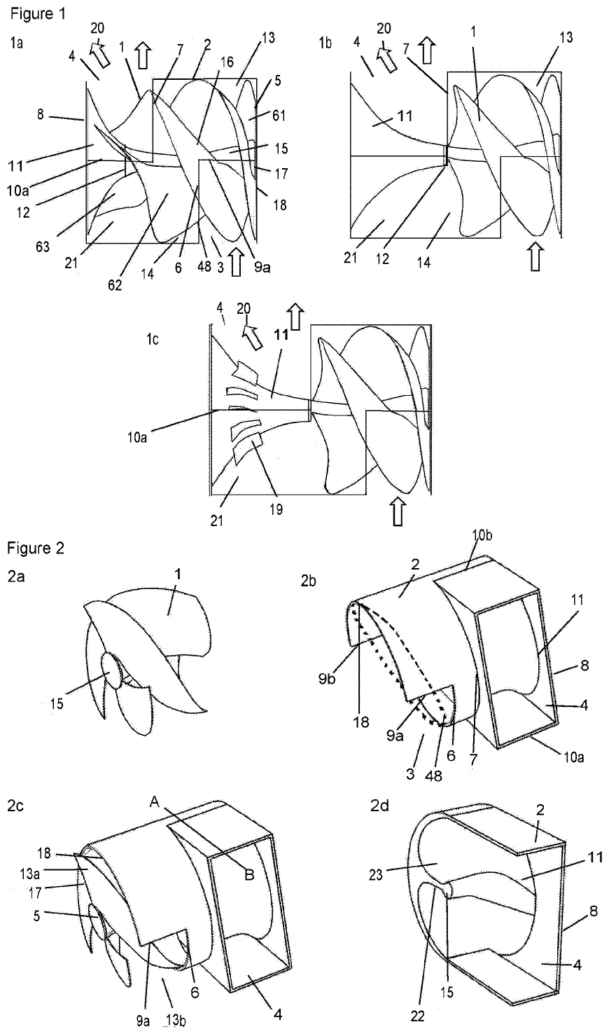

FIG. 1a is a side view of a rotor (1), housing (2) and elongate stator (11). In this embodiment, blade (16) extends from a substantially helically shaped first portion (61) from a first longitudinal limit (5) in a first end portion (13) where it approaches perpendicular alignment with axis (15). Blade (16) gradually unfolds as it approaches parallel alignment with longitudinal axis (15) at a second longitudinal limit (6) of the first end portion (13).

Blade (16) of a substantially helically shaped second portion (62) is fully enclosed in the second end portion (14) by housing (2). This enables pressure to build up within the second end portion (14).

Blade (16) of a substantially helically shaped third portion (63) tapers off from the third longitudinal limit (7) from a first end of a third end portion (21) at second opening (4). In the third end portion (21), the substantially helically shaped third portion (63) transitions to an elongate stator (11) which extends from a first end (12) of elongate stator (11) to a fourth longitudinal limit (8) of the third end portion (21). Axis (15) may or may not rotate through the centre of the elongate stator (11) depending on which end the motor is located. The elongate stator (11) may support the rotor (1) at axis (15) and serve to direct flow in the desired flow direction.

In some cases the elongate stator (11) may be part of the housing (2) or may rotate independently from rotor (1) along with some or all of housing (2). In some applications this can be useful to enable a change of flow direction.

Axis (15) can be shaped in a way to aid flow along rotor (1) such as a slightly increased diameter at a first longitudinal limit (5) of the first end portion (13) to a narrow diameter in the second end portion (14) to an increased diameter in the third end portion (21).

Blade (16) in the third end portion (21) tapers off as a result of both the blade (16) diameter diminishing as well as the elongate stator (11) diameter around the centre increasing. This causes flow path (20) from the third end portion (21) to be at an increasingly acute angle to longitudinal axis (15). Blade (16) can overlap longitudinally with elongate stator (11) in the third end portion (21) and be detached from it.

The first opening (3) in housing (2) can extend from a first longitudinal limit (5) to a second longitudinal limit (6) and from a first lateral limit (9a) to a second lateral limit (9b) along and around longitudinal axis (15) in the first end portion (13).

The second opening (4) is longitudinally offset from the first opening (3) along and around the longitudinal axis (15), and is substantially aligned with elongate stator (11) and the end portion of blade (16). The second opening (4) extends from a third longitudinal limit (7) of the third end portion (21) to the fourth longitudinal limit (8) of the third end portion (21) and from a third lateral limit (10a) to a fourth lateral limit (10b) along and around longitudinal axis (15).

In some cases, the first lateral limit (9a) is the same as the second lateral limit (9b) or the third lateral limit (10a) the same as the fourth lateral limit (10b) indicating that the arc openings (3) or (4) extend 360 degrees around the circumference. Preferably, the first lateral limit (9a) is not the same as the second lateral limit (9b) for most of the length along the first portion (13) and is limited to the first portion (13a) of first end portion (13) because tests have shown that fluid can be lost when this is not the case.

FIG. 1b is a side view of a rotor (1), housing (2) and elongate stator (11) but in this embodiment, blade (16) does not extend into the third end portion (21) but finishes near the third longitudinal limit (7) of the third end portion (21). Whether or not blade (16) extends into the third end portion (21) may depend on the application. It was found in testing that the embodiment in FIG. 1a provided more pressure and volume than FIG. 1b, but also consumed more power.

FIG. 1c is a side view of a rotor (1), housing (2) and elongate stator (11) like FIG. 1b but further comprises vanes (19) as part of the elongate stator (11). Vanes (19) or other similar vanes that align substantially parallel with the longitudinal axis (15) can help to direct fluid towards second opening (4) and prevent the tendency to continue in a spiraling motion around elongate stator (11). Vanes (19) may extend the full or partial length along stator (11) and may differ in depth. Their location will also depend on the location of the third and fourth lateral limits (10a) and (10b) that define the circumference of the second opening (4). Other methods to smoothly direct and more evenly distribute flow out second opening (4) can include, for example, directional vents around the longitudinal axis (15) within second opening (4) or other means described in FIGS. 2-5 for example.

FIGS. 2a-2d are perspective views of various parts of one embodiment. FIG. 2a describes the rotor (1) like that of FIG. 1b, and FIG. 2b an embodiment of a housing (2). In this embodiment, the elongate stator (11) can be part of housing (2). The second opening (4) extends from the third longitudinal limit (7) to the fourth longitudinal limit (8) of the third end portion (21) and from the third lateral limit (10a) to the fourth lateral limit (10b) along and around longitudinal axis (15) in the third end portion (21).

The first opening (3) extends from a first end (17) to a second longitudinal limit (6) in the first end portion (13), and extends around the circumference from the first and second lateral limits (9a) and (9b). In this embodiment the second lateral limit (9b) is at about 180 degrees around the circumference of housing (2) from the first lateral limit (9a).

However, the dotted line shows another embodiment. In this case, the first and second lateral limits (9a and 9b) and their corresponding longitudinal limits (48) between second longitudinal limit (6) and first end (18) of housing (2) define the first opening (3) along the first end portion (13) of housing (2). Thus lateral limits (9a and 9b) may not necessarily be parallel with the axis. The lateral and longitudinal coordinates (9a, 48 and 9b, 48) may define the first opening (3) as elliptical rather than stepped as shown by the dotted line in FIG. 2b. In fact, there may be a number of longitudinal limits (48) according to its longitudinal position along the substantially helically shaped first portion (61) between the first end (18) of housing (2) and the second longitudinal limit (6) of opening (3). The objective is to prevent losses from air spilling out from the intake at the first opening (3).

It is known that fluid losses from the first opening (3) occur if the first opening (3) extends beyond a second longitudinal limit (6) of the first end portion (13) where it approaches parallel alignment with longitudinal axis (15) but subsequent tests revealed two additional phenomena. A relatively short full circumference at first opening (3) for a first portion (13a) of the first end portion (13) significantly increases the volume and pressure of a fluid intake and does not result in losses. FIG. 2c is an embodiment of this showing the first end (18) of housing (2) located further along the first longitudinal limit (5) of rotor (1). However, tests also found that extending the first lateral limit (9a) too close to the second lateral limit 9b such that housing (2) in a second portion (13b) of the first end portion (13) was less than a fifth of the total area of the cylinder, resulted in significantly decreasing efficiency due to fluid losses. This discovery demonstrates the importance of the critical lateral limits (9a and 9b) around the circumference to define the first opening (3).

Not all applications allow for a first opening (3) on all sides but in applications that do allow for this, the first end (18) of housing (2) can be set back from the first longitudinal limit (5) of the first portion (13a) of the first end portion (13) while a second portion (13b) of the first end portion (13) may be limited by the first and second lateral limits (9a and 9b). The exact location of the first end (18) of housing (2) in relation to blade (16) along axis (15) within first end portion (13) will depend on factors such as the chosen rpm to achieve a certain pressure and volume. For example, at the same location of the first end (18) of housing (2), a very high rpm (rotations per minute) could cause some losses whereas a lower rpm may not cause any.

Thus the longitudinal and lateral limits (6), (18), (9a) and (9b) at fluid intake of the first opening (3) in housing (2) are all critical to efficiency and to prevent fluid loss.

On the other hand, longitudinal and lateral limits (7), (8), (10a) and (10b) at the second opening (4) in housing (2) function mainly to control the exhausted flow path while minimizing resistance and noise. They are not critical in causing fluid loss as is the case with opening (3).

FIG. 2d is a cross-sectional perspective view of one embodiment of elongate stator (11) across the line A-B shown in FIG. 2c. In some cases, axis (15) of rotor (1) may run through the center of elongate stator (11) which can be part of housing (2). This example describes a saddle (22) connecting the center of elongate stator (11) that supports the axis (15) to the furthest part of the elongate stator (11) opposite the second opening (4). This embodiment shows how elongate stator (11) can increase in cross sectional area due to an increasing diameter around the center and a thickening inside the periphery of elongate stator (11) opposite the second opening (4), in such a way as to smoothly direct fluid out the second opening (4) to either side of axis (15). One or more concave channels (23) formed between the saddle (22), and the back, center and sides of the stator (11) progressively drive fluid towards the second opening (4)

This is one example only of a stationary stator. Its shape will vary according to the application. For example, stator end at the fourth longitudinal limit (8) may not be perpendicular to the axis but instead tilt at an angle, possibly curved, so that a fluid is directed diagonally out the second opening (4). There may be several second openings (4) with a saddle (22) or there may be no saddle (22) at all as described in FIG. 1a. It will depend on the intended direction or directions of the exhaust fluid and the two options of blades as shown in FIGS. 1a and 1b. The surface of saddle 23 can be curved/convex. This can be useful in a context of a water pump or turbine so that the fish life or water-weed are not caught between the blade and the stator for example, but instead slide to either side. The shapes of elongate stator (11) will all depend on the context, application and objective.

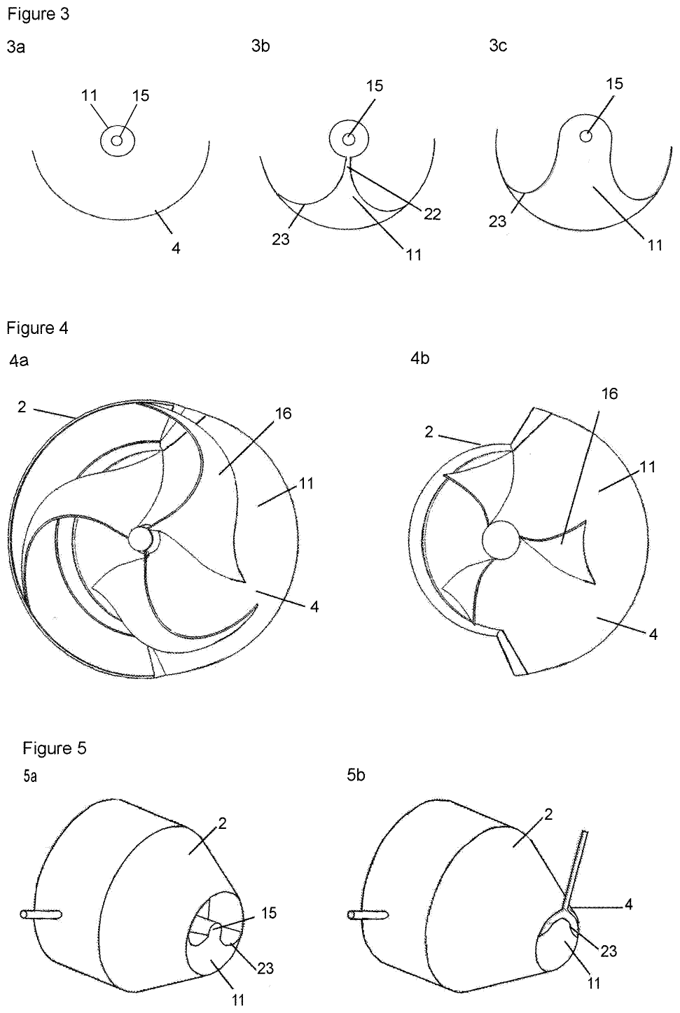

FIGS. 3a-3c are further cross-sectional views of elongate stator (11) from the embodiment described in FIG. 2d. Elongate stator (11) gradually increases in cross-sectional area along the longitudinal axis (15) beginning at FIG. 3a around axis (15) to a saddle (22) in FIG. 3b and an increasing cross-sectional area along the wall of housing (2) opposite opening (4). Two concave channels (23) shown in FIGS. 3b and 3c direct flow at an increasingly acute angle along the longitudinal axis (15) towards the fourth longitudinal limit (8) of the third end portion (21). For some embodiments such as that described in FIG. 1a where rotor (1) extends into the third end portion (21), elongate stator (11) with a saddle (22) and concave channels (23) as described in FIGS. 3a-3c would not be possible and would require an alternative shape.

FIG. 4 is an example of elongate stator (11) for the embodiment described in FIG. 1a. The objective here is to also encourage fluid flow out the second opening (4) while maintaining good pressure and volume. In this case, the contour of elongate stator (11) along the wall of the housing (2) opposite the second opening (4) closely cooperates with the contour of blade (16) as it rotates. This elongate stator (11) can form a funnel as shown by the side view of FIG. 1a in order to encourage fluid to flow smoothly out the second opening (4).

The elongate stator (11) can stand alone or be moulded into housing (2) in order to follow the contour of blade (16) as it rotates. FIG. 4b is an example of a reduced housing (2) on one side along a portion of the housing. The choice between these options may be based on cost and ease of manufacture and assembly.

FIG. 5a is a perspective view of another example where housing (2) progressively reduces in diameter as elongate stator (11) increases in cross sectional area along the third end portion (21). In this embodiment, elongate stator (11) around axis (15) comprises concave channels (23) to progressively direct fluid flow under pressure towards a relatively small second opening (4) as described in FIG. 5b. The application may be as a pump for example.

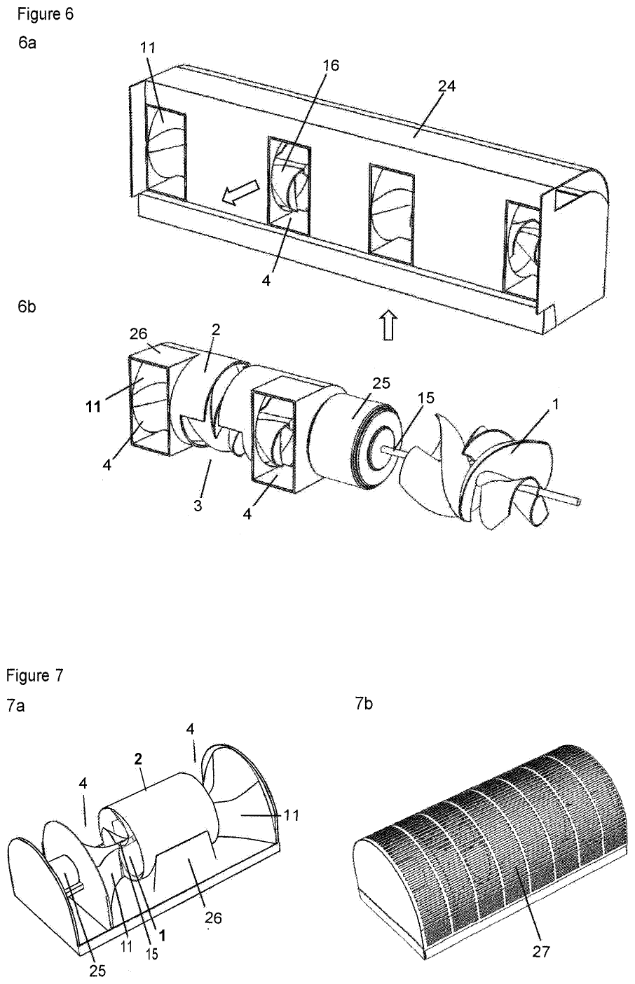

FIGS. 6a and 6b are perspective views of an example of an application for use in a building to ventilate such as between rooms or between a room and the outside on an external wall. This solution provides a long, narrow and spatially compact design. FIG. 6a describes two rotors 1 of opposite chirality side by side within a second housing (24). This can be set into the wall cavity, such as above a window, to supply or exhaust air described here from four second openings (4). In this example, first opening (3) for supply air is from below.

FIG. 6b is an example of the components inside the outer housing (2) in this ventilation application. Two rotors 1 of opposite chirality can be rotated along longitudinal axis (15) by one centrally located motor (25). In this example, the first opening (3) is wider on one side of housing (2) than on the other side to increase volume and pressure without losses as described earlier for FIGS. 2a-2b. Elongate stator (11) smoothly directs flow to one side of axis (15) out second openings (4).

In some applications with some modifications, all or part of housing (2) can rotate independently of rotor (1) or duct (26) such that the flow path is reversed. For example, duct (26) can be positioned on opposite sides of housing (2) (not just one side) and remain fixed in position while housing (2) can rotate independently of rotor (1). By rotating housing (2), the second opening (4) could be from one side of the axis (15) or alternatively from the other side. Such a duct (26) can also be positioned on both sides of housing (2) such that the first opening (3) can be from either side of axis (15) when housing (2) rotates as a cylinder. This could be useful in the application of a fan alternatively supplying or exhausting air for example.

Another embodiment may include a housing (2) wherein the third end portion (21) of housing (2) with elongate stator (11) rotates independently from the first and second portions. An application like this can allow for a changing direction of flow path out the second opening (4). These examples demonstrate the considerable flexibility of application since first and second openings (3 and 4) can be from any side relative to each other and where all or part of housing (2) can rotate independently of rotor (1).

FIG. 7a-7d are perspective views of an application of rotor (1), housing (2) and elongate stator (11), for example as a wall-mounted fan drawing in air from one side of the wall and exhausting to the other side of the wall. In this example, the only moving part is rotor (1) comprising blade (16) of opposite chirality and axis (15) powered by motor (25). Housing (2) is fixed in position in a surface-mounted structure (26). Stators (11) on either side of rotor (1), as shown in FIGS. 7a and 7d, can be fastened to the wall-mounted structure (26) and shaped to encourage fluid to smoothly and evenly flow outwards from all sides of the longitudinal axis (15) except for one side as described by the distribution of grills (27) in FIGS. 7b and 7c. Elongate stator (11) again progressively widens around axis (15). Saddle (22) can connect to surface-mounted structure (26) as it progressively drives air outwards from axis (15). FIG. 7c shows intake opening (3) from the flat side of the surface-mounted structure (26). In this case too, as in FIGS. 6a-6b, the fan may switch from a supply to an exhaust fan with modifications to stator (11) such that the rotation of portions of housing (2) could block or unblock openings (3) or (4) to allow for either supply or exhaust air.

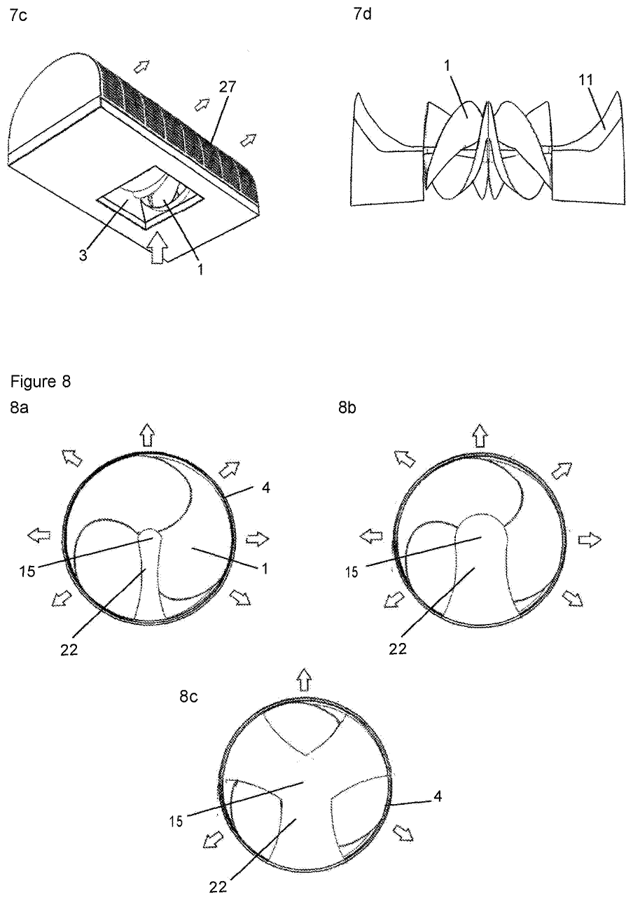

FIGS. 8a-8b are cross-sectional views along the third end portion (21) and elongate stator (11). FIGS. 8a and 8b show a widening saddle (22) along axis (15) as it approaches the fourth longitudinal limit (8) of the third end portion (21), thereby driving fluid outwards as indicated by the arrows.

FIG. 8c is also a cross-sectional view along the third end portion (21) and elongate stator (11) but in this example one or more saddles (22) and concave channels (23) drive air towards multiple second openings 4.

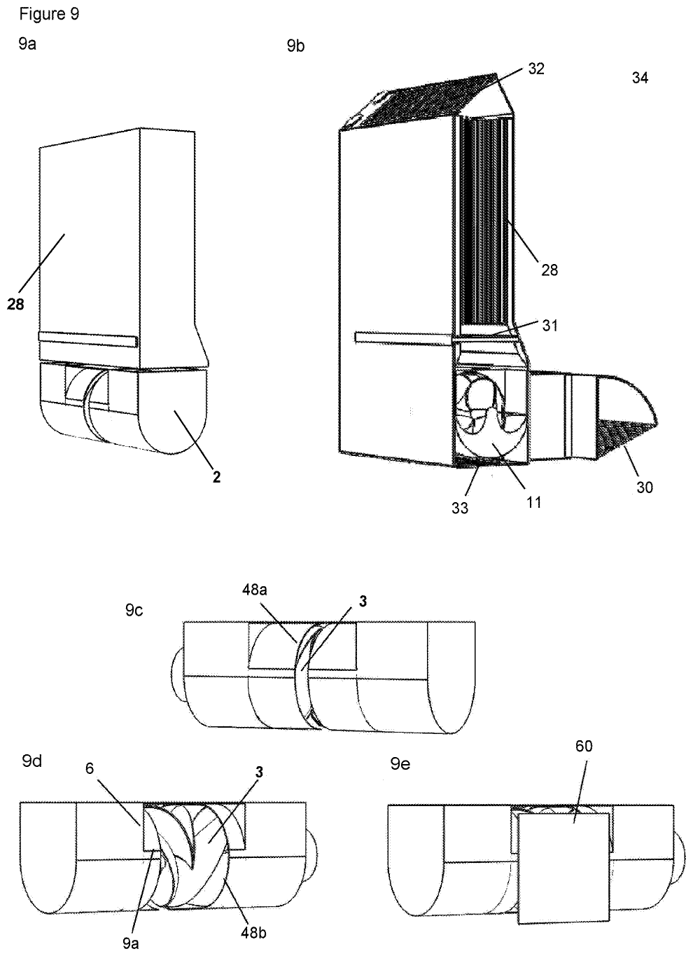

FIGS. 9a-9e are perspective views of an embodiment of rotor (1), housing (2) and elongate stator (11) in a heating/cooling application comprising heat exchange components (28) in a building (34). FIG. 9b describes two forced flow paths by means of rotor (1)—one from exterior vent (30) and another from a first interior vent (33) through filter (31), heat exchange components (28) to second interior vent (32). The first interior vent (33) may open or partially open to the inside of the building (34) by means of a sliding vent for example. The exterior vent (30) may open substantially 270 degrees from the heat exchange components (28) by means of a sliding vent or damper (60) opening or partially opening to the outside of the building (34) for example.

Elongate stator (11) is facing in a direction to force fluid through the heat exchange components (28).

FIGS. 9c-9d describe three different longitudinal limits (48a and 48b) and the second longitudinal limit (6) at the end of the first opening (3) around longitudinal axis (15). Longitudinal limits (48a, 48b and 6) may also form a curve to form a wide opening (6) to a narrow opening (48a). The objective is to locate the lateral (9a and 9b) and longitudinal limits (48a, 48b and 6) around the longitudinal axis (15) such that fluid flow remains contained within housing (2) as rotor (1) rotates at different speeds. As already mentioned, it was found in tests that continuing the full width of second longitudinal limit (6) around the entire circumference caused losses of fluid leading to volume and pressure loss.

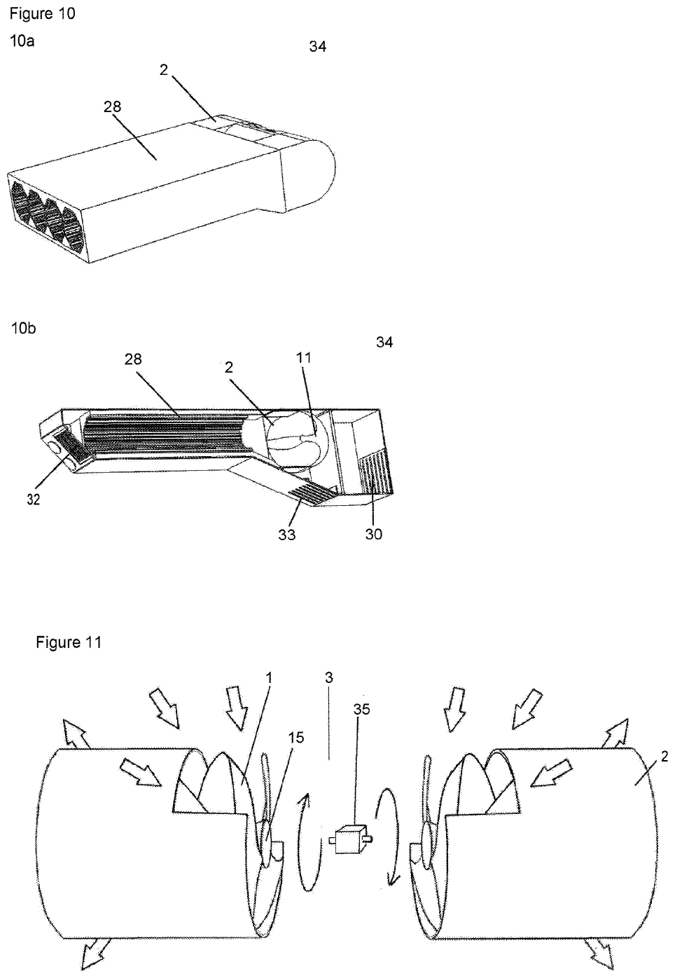

FIGS. 10a-10b are similar to FIGS. 9a-9c except that rotor1, housing (2) and elongate stator (11) are arranged such that the two flow paths are reversed. One flow path is from the building (34) through first interior vent (33) which is substantially 270 degrees from the direction of flow through the second interior vent (32) while the other flow path from outside the building through exterior vent (30) is substantially directly opposite the heat exchange components (28). Openings in vents (30) and (33) can be controlled to allow air to enter from inside or outside the building, such as sliding vents.

FIG. 11 is a perspective view of an embodiment of co-axial rotors (1) of opposite chirality in housing (2). By inverting rotational direction, such as by means of bevel gears (35), two rotors can be timed and controlled to cancel out the torque of each other. In other words, one rotor (1) is rotating in the reverse direction to the other. This improves symmetry of forces around axis (15). The use of coaxial rotors is evident with coaxial helicopter blades for example which eliminates the need for a tail rotor to prevent the helicopter from turning due to the torque created by the main rotor. One application that could use a means of inverting rotational direction with co-axial rotors (1) could be, for example, the propellers in a drone.

FIG. 11 describes first openings (3) on the same sides but these can also be on one or more sides of longitudinal axis (15). Second opening (4) can also be on any side. In some applications, part or all of housing (2) can rotate independently from rotor (1) and longitudinal axis (15) resulting in flexibility of flow path or direction of force exerted for navigation purposes for example.

FIG. 12 is a perspective view of a vertical axis wind turbine (VWAT) (57) comprising a pair of rotors (1) of opposite chirality and a pair of stators (11) at either end to direct air outwards from the longitudinal axis (15) at second openings (4). One or more blades (16) are preferably cupped or concave. This not only directs a fluid to both ends of the axis but also helps to reduce drag at the back of blade (16). In some cases, it may be desirable to exhaust to one end only in which case one rotor would be ample.

One or more baffles (36) can be included along concave blade (16) preferably in the first end portion (13). These create some resistance against fluid flow as blade (16) approaches perpendicular alignment with longitudinal axis (15) at the first longitudinal limit (5). This in turn provides significantly more force to rotate rotor1.

The rotor (1) as described in FIG. 12 can also be a fan, for example, provided baffles are not included. It is mechanically possible to switch between applications. For example, if there is insufficient wind and it is still important to capture and filter air, then the VWAT (57) can function as a fan.

Rotor (1) in a fan, propeller or pump is rotated in the opposite direction than the rotational direction in a turbine such as a VWAT (57) or water turbine that is pushed by an external force. The objective with a turbine is to increase its torque when rotated by an external force in order to increase the amount of power generated. Baffles (36) in the blades fulfil this function. Opening (3) extending across the first end portion (13) and the second end portion (14) in the example of the VWAT (57) also fulfils this function. In this context, the additional length of blade (16) increases the rpm and the torque of the rotor (1). In contrast, first opening (3) extends across only the first end portion (13) in the case of a fan, propeller or pump where it is preferable to minimize torque in order to minimize power consumed.

Tests showed that partially closing one side of the turbine with housing (2), helped to increase the volume captured above and below. This bears similarities with similar findings in tests carried out on the fan/propeller/pump.

A first gap (37) between blade (16) and axis (15) can allow trapped air to escape, thereby reducing a build-up of negative pressure behind blade (16). The first gap (37) may extend into portion (14) or may be limited to portion (13) or a part of portion (13). Also, gap (37) can be very much wider than the arc length of blade (16) since increasing the diameter of the outside of blade (16) and decreasing its weight increases its torque.

Similar principles apply to other fluids such as water e.g. water turbine.

FIG. 13 is a perspective view of the first end portion (13) of blade (16). This embodiment comprises one or more baffles (36) in the first end portion (13) along concave blade (16). A second gap (38) between the edge of the baffle (36) and the concave surface of blade (16) allows air to continue to flow along blade (16) but under increased pressure providing more torque. Baffle (36) can be curved allowing air to flow in a similar direction to blade (16) underneath and over baffle (36). Tab (39) connects baffle (36) to blade (16) on both sides. Preferably the initial edge of blade (16) starting at the first longitudinal limit (5) of first end portion (13) is shaped in such a way as to scoop air into blade (16) creating a relatively large volume of fluid that can then be squeezed through gap (38), created between baffle (36) and blade (16), or skims above baffle (36). In this embodiment, initial edge of blade (16) is shown to curve inwards near the middle of blade (16) but it can also curve outwards. The objective is to shape the edge in order to provide a streamline approach to the fluid and to optimize intake of the fluid, and increase volume, torque and rpm in order to generate more power, but it is understood that other shapes could also achieve this objective.

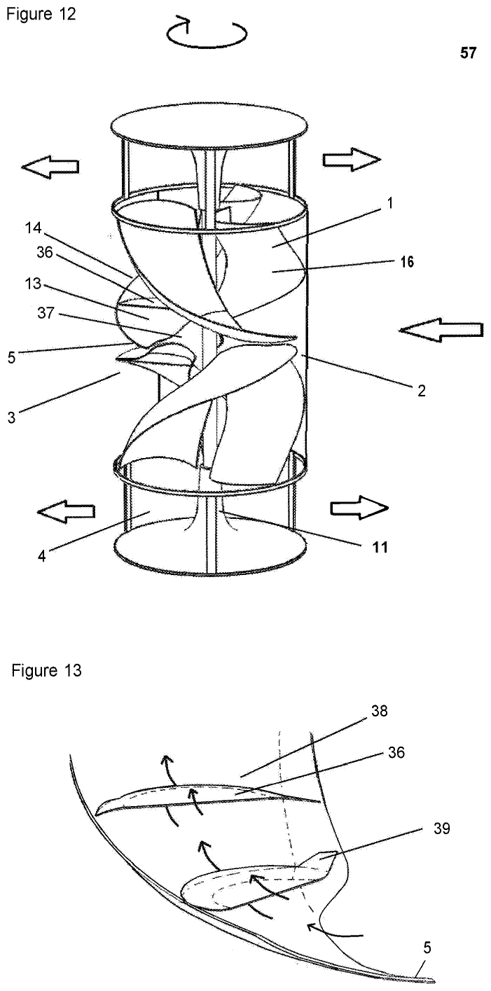

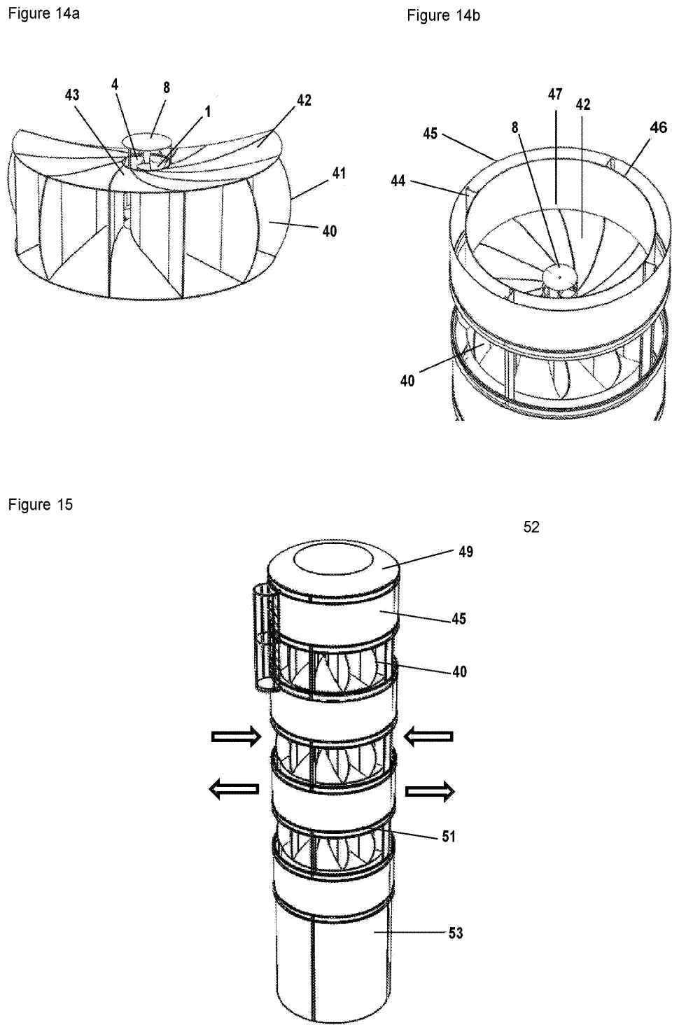

FIG. 14a is a perspective view of an example of a VWAT (57) and ODGV (40). In this embodiment, the ODGV (40) radiate around substantially half of the VWAT (57). This can be useful in applications where the VWAT (57) and ODGV (40) are connected to the side of a building for example. The objective is to increase the catchment area and to channel wind towards one side of the VWAT (57) in order to optimize wind speed on one side of the VWAT (57) and minimize drag on the other side. Wind is directed between ODGV (40) and amplified in flow rate due to the inward funneling shape of the cavity limited by ODGV (40) and decreasing distance between lateral vanes (42). When ODGV (40) are at an acute angle (43) relative to the tangent to the VWAT (57), the increased wind speed directed on one side only of the VWAT (57) significantly increases its rpm, torque and volume. In this example ODGV (40) is convex along its outer edge (41) but at other times it can be concave or straight. The surface of OCGV (40) can itself be curved or straight. The objective is to capture wind and optimize its speed whatever direction the wind is blowing.

FIG. 14b is a perspective view of another embodiment of VWAT (57) and ODGV (40) but this time it is described with ODGV (40) radiating right around VWAT. It can include a first structural support (44) that holds the VWAT (57) and ODGV (40) in position and a cavity (47) above or below VWAT (57) and ODGV (40). VWATs can be stacked on the side or corner of a building or free-standing as a tower. Some applications for the VWAT, other than energy generation, could be to filter carbon from exhausted air from second opening (4) and the cavity (47). It could include a means (29) of capturing carbon such as a carbon filter (46) preferably washable, electromagnetic to enhance particle capture and impervious to harsh conditions. Another means may be plants partially or totally around the circumference that also serves to filter air. An outer surface (45) of cavity (47) could comprise flexible solar panels for example to provide a mix of electricity generation means, or the outer surface (45) could provide a means of advertising. It is preferable that gaps in, below or above outer surface (45) should still allow air to escape. When integrated into the side of a building, the VWATs could also contribute to the ventilation of the building. Other options would be to replace the VWAT with a ventilation fan as described in FIGS. 1a and 1b, for example in the lower levels of stacked VWATs where the wind speed can be lowest and the pollution greatest.

FIG. 15 is a perspective view of a tower (52) comprising stacked VWATs (57), ODGVs (40) and cavities (47) between VWATs (57). This can be water-proofed by a roof (49) that can also comprise a means of generating energy from solar. If plants are incorporated outside cavity (47) to filter air, then a gutter can water the plants. Vertical structural support (44) can comprise a means of a horizontal structural support (51) for a ladder. The tower can include a means of storing power (53) such as in the base of the tower. This would provide co-location of wind and solar energy generation and power storage. This can be used for vehicle docking, or other surrounding power requirements.

Several buildings can form a natural wind tunnel so this type of positioning would be ideal. In addition, it would allow for an interesting and pleasing façade allowing some advertising, carbon capture or solar generation opportunities between VWATs. All these options discussed and more, can contribute to carbon neutral buildings and transport and a cleaner environment, especially when located in the urban environment itself.

FIG. 16a is a cross-sectional perspective view of another embodiment of rotor (1) as a VWAT (57). The first gap (37) between blade (16) and axis (15) is very wide in this case while the ODGV (40) are relatively small compared to the previous embodiments. In fact, in some cases the ODGV (40) may not be employed since the inner cylindrical wall (50) is contributing to guiding wind in the correct direction to exert force on the blade (16). Housing (2) also helps to contain the wind so that it can be captured above and/or below the VWAT (57). Housing (2) may be rotatable independently of rotor (1) and blade (16) or inner cylindrical wall (50). It was found through tests that the proportions of blade (16), first gap (37) and ODGV (40) of FIG. 16 improved results compared to those of FIG. 13. Even though the ODGV (40) of FIG. 13 significantly increased wind speed as much as three times thereby reducing the cut-in speed and increasing the rpm and torque, the results of FIG. 16 for a VWAT of similar size overall (including VWAT and ODGV) were still much improved due to the increased diameter of the blade around the outer periphery of the VWAT (57) thereby significantly increasing the torque and power generated.

In a similar way to that described in the stacked VWATs (57), this embodiment can also incorporate one or more cavities (47) and an outer surface (45) that could also capture air and water from the air or comprise flexible solar panels for example around the circumference to provide a mix of electricity generation means, or a means of advertising.

FIG. 16b is an embodiment of blade (16) as described in PCT/NZ2018/050010 while blade (16b) can be a proportion of blade (16) or alternatively the full complete length of blade (16)

FIG. 16c is a cross sectional view and 16d is a cross sectional perspective view. These examples show how the acute angle (43) of ODGV (40) in relation to the VWAT directs wind (54) on one side of rotor (1) targeting the concave curve of blade (16). The inner cylindrical wall (50) is also diverting air along the blades. In fact, the ODGV (40) may not be necessary due to the function of the inner cylindrical wall (50). The angle of the wind (54) approaching at an acute angle to the first opening (3) increases results. The housing (2) is also important to contain air while it exerts force on the blades (16). In order to respond to optimize the direction of wind on the VWAT (57), the ODGV (40) may be louvers that can close or open right around the VWAT according to the wind direction. Alternatively the housing (2) may be able to rotate independently in response to the wind direction.

In one embodiment, blade (16) is increasingly concave approaching the second end portion (14), and can be angled to face outward from the longitudinal axis (15) as can be seen by the orientation of the one or more baffles (36) in FIG. 16c in relation to the ODGV (40). In other words, a line through the center of a cross section of rotor (1) may show that the inner edge of the arc of blade (16) is forward from the outer edge of the arc of blade (16). Blade (16) can be substantially acutely and/or perpendicularly aligned to the wind direction (54). In some cases longitudinal axis (15) may be detached in part or wholly from blade (16).

FIG. 16d is an embodiment of a VWAT (57) showing the benefits of an arrangement of VWATs (57) side by side. Tests showed a very large increase in wind entering the VWAT (57a) due to air flowing around housing (2) of VWAT (57b) between its first opening (3) and the first opening (3) of VWAT (57a). The location of cavity (47) can be from either end of stacked VWATs as shown in FIG. 15.

FIG. 16e is an embodiment of a VWAT (57) with a first and second set of blades (16 and 64). Similar to the first set of blades (16) cooperating with the first inner cylindrical wall (50), second inner cylindrical wall (65) can also cooperate with the rotation of the inner set of blades (64). Inner cylindrical walls (50 and 65) can be stationary or they can rotate independently or together in response to the direction of wind in order to optimize the energy yield. An opening (3) in housing (2) and an opening in the first inner cylindrical wall (50) allows the majority of wind to push both the first and second set of blades (16 and 64)

The objective of the second set of blades (64) and second inner cylindrical wall (65) is to increase the amount of wind turned into useful energy. Wind at a perpendicular angle to the first inner cylindrical wall (50) tends to sheer off both sides of the first inner cylindrical wall (50) causing some losses. However, the majority of this loss can be captured as it enters through the opening in the second inner cylindrical wall (65) and, due to the reduced diameter of the second set of blades (64) and tangential angle approaching the blades, the wind will create additional torque on these blades (64).

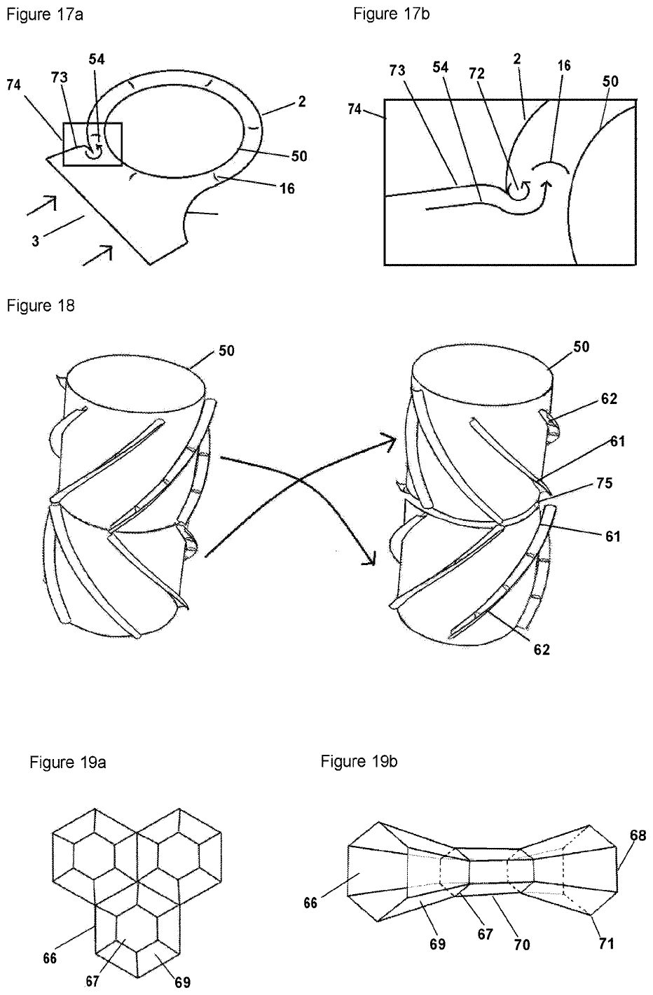

FIG. 17a is a cross-sectional view of one embodiment of the rotor 1 with blades (16). FIG. 17a is a close-up view of region (74) of VWAT (57). Opening (3) is very similar to that described in FIGS. 16a to 16e except for one detail. The shape of housing (2) at region (74) of VWAT (57) in some cases depending on the orientation of blade (16) can make a substantial difference to the amount of torque and power generated. It would seem counter-intuitive to direct wind (54) in the opposite direction from the direction of rotation of blades (16) on this side of opening (3). However, it was found that this can create a whirlwind effect or vortex (72), depending on the orientation of the concave surface of blade (16), which pushes blade (16) forward between inner wall (50) and housing (2) such that the amount of torque can be significantly increased.

FIG. 18 are perspective views of embodiments of blade (16) wherein blades (16) of opposite chirality are interchangeable. For example, the first and second substantially helically shaped first portions (61) and the first and second substantially helically shaped second portions (62) can direct a fluid to a central portion between the first and second substantially helically shaped first portions (61). Generally blade (16) will rotate clockwise or anticlockwise according to the orientation of its concave surface. If wind is directed towards the central portion, then a gap (75) in this central portion can be included around the periphery of the inner cylindrical wall (50) allowing some air to escape inside the inner cylinder where it can be captured at one or both ends.

FIG. 19a is a cross-sectional view of an example of a cooling and water-collecting device comprising interconnected hexagonal openings and FIG. 19b is a perspective view of the same. This arrangement can be incorporated around the walls of the cavity (47) between VWATs as described in FIGS. 12-16e in order to collect water from the exhausted air. As air flows through one or more venturi tubes, pressure is relatively high at a larger first opening (66) of the venturi tube but is relatively lower at the second opening (67) of the venturi tube after funneling through a first venture tube housing (69). Due to the pressure drop, air is cooled allowing condensation to take place in the second venturi tube housing (70) where condensate (71) can be collected from a third opening (68) of the venturi tube. Cylinders or other shapes can be used to achieve the same objective but hexagons are advantageous in this context because the first venturi tube housing (69) allows all the air to be funneled through with minimum resistance.

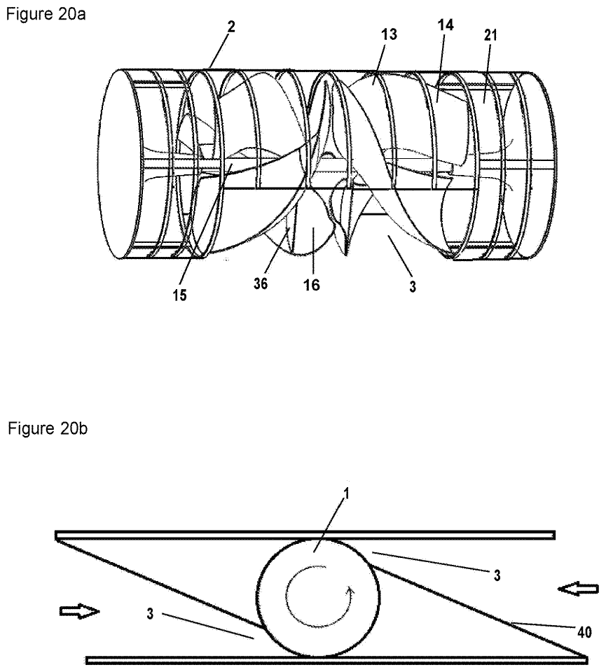

FIG. 20a is a perspective view of a rotor (1) similar to that of FIG. 16 with one or more baffles (36) in an application as a water turbine partially or wholly submerged in the water. Whether driven by wind or water current, one or more baffles (36) in blade (16) would contribute significantly to increasing torque and rpm to generate power. The second opening (4) (not shown here) is longitudinally offset from first opening (3).

FIG. 20b is a cross sectional view of rotor (1) and ODGV (40) in an application of a water turbine. For example, in the case of a tidal current, the rotor (1) would rotate whether the tide is coming in or going out via first openings (3). Housing (2) in the third end portion (21) that comprises second opening (4) to expel water can be made to rotate separately from either rotor (1) or from housing (2) of the first and second portions (13 and 14). This ability to rotate in the third portion can be useful to allow the water to continue to flow out in the same direction as the current. In a similar way to a small windmill, a vane connected to the third portion for example, may rotate the third portion according to the direction of the current.

In the case of a river where the current is going in one direction only, then first opening (3) and ODGV (40) can be on one side only.

An arrangement similar to FIGS. 16a-16e such as a vertical array of water turbines would also work since water is a fluid like air. Similarly also, it may incorporate a means of collecting waste in the water at one or both ends flowing through by the action of the blades (16).

As described by FIGS. 1-20, the stator and the casing of the helical rotor can be shaped according to the desired direction of flow depending on the application.

All the embodiments described so far can apply to a rotor of opposite chirality or to a single rotor, and can be applicable in different applications. They are not limited to a particular orientation nor are the openings limited to the embodiments in the figures. Elongate stator (11) is also not limited to the shape described here. It can be shaped according to the size of opening and the application with the objective to smoothly manipulate flow direction. The blades (16) are also not limited to a particular number nor are its baffles in the case of a VWAT for example.

The invention may be said broadly to consist in the parts, elements and features referred to or indicated in the specification of the application, individually or collectively, in any or all combinations of two or more of said parts, elements or features. Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A device comprising a rotor, the rotor comprising:
an elongate first portion (61) having a longitudinal axis (15) and at least one pair of blades (16), wherein at least one blade (16) extends from the first end portion (13),
the blade (16) having a root which is substantially helically shaped to the longitudinal axis (15) with a flat and/or concave pressure face,
a first opening (3) defining the fluid intake provided substantially axially aligned with the substantially helically shaped first portion (61);
a second opening (4) defining a fluid outlet longitudinally offset from the first opening,
wherein the first opening (3) is defined by one or more first and second lateral limits (9a and 9b) around the circumference of housing (2) and their corresponding longitudinal limits (48) between a first end (18) of housing (2)
and wherein the surface area of housing (2) between lateral and longitudinal coordinates (9a, 9b, 48) amounts to at least a fifth of the total surface area of housing (2) and first opening (3) between the first end (18) of housing (2) and the second longitudinal limit (6)

2. A device as claimed in claim 1 wherein the root in the first portion (61) is substantially helically shaped to the longitudinal axis (15) according to a logarithmic, exponential, power or other sequencing such that the tangent to the blade (16) approaches perpendicular alignment to the axis (15) at a first end (5) of the first end portion (13), and a first end (17) of the first opening (3), and approaches parallel alignment to the axis (15) at a second longitudinal limit (6) of the first end portion (13), and a longitudinal limit (48) of the first opening (3)

3. A device as claimed in claim 2, comprising a third end portion (21)
wherein the third end portion (21) comprises the second opening (4) defining the fluid outlet provided substantially axially aligned with a third substantially helically shaped portion (62) and an elongate stator (11) extending from the third substantially helically shaped portion (62);
wherein the second opening (4) extends from a first longitudinal limit (7) to a fourth longitudinal limit (8) of the third end portion (21) and from a third lateral limit (10a) to a fourth lateral limit (10b) around the circumference of housing (2);
wherein the elongate stator (11) defines the flow path (20) towards the second opening (4);
wherein the flow path (20) from the second opening (4) is at an acute and/or right angle to the longitudinal axis (15);
a second substantially helically shaped portion (62) enclosed by housing (2).

4. A device as claimed in claim 3, the elongate stator (11) cooperating with the inner and outer edges of blade (16) as blade (16) rotates in third end portion (21)
wherein the diameter of blade (16) decreases and the cross-sectional area of elongate stator (11) increases from the third longitudinal limit (7) to the fourth longitudinal limit (8)

5. A device as claimed in claim 3, comprising:
one or more saddles (22) connecting the centre of the elongate stator (11) that supports axis (15) to the outer periphery of the elongate stator (11) opposite one or more second openings (4);
wherein the elongate stator (11) increases in cross-sectional area from the third longitudinal limit (7) to the fourth longitudinal limit (8);
wherein the elongate stator (11) comprises concave channels (23) on either side(s) of one or more saddles (22) to direct flow at an increasingly acute angle along the longitudinal axis (15) towards the fourth longitudinal limit (8) of the third end portion (21).

6. A device as claimed in claim 4 or 5, the first end portion (13) comprising:
a first portion (13a) of the first end portion (13);
wherein the first lateral limit (9a) is the same as the second lateral limit (9b) to form a first opening (3) around the entire circumference.
a second portion (13b) of the first portion (13) between lateral and longitudinal coordinates (9a, 9b, 48) and between the first end (18) of housing (2) and the second longitudinal limit (6) of the first end portion (13)
wherein the surface area of housing (2) between lateral and longitudinal coordinates (9a, 9b, 48) and between the first end (18) of housing (2) and the second longitudinal limit (6) of the first end portion (13) amounts to at least a fifth of the total surface area of housing (2) and first opening (3) between the first end (18) of housing (2) and the second longitudinal limit (6)

7. A device as claimed in claim 4 or 5, wherein the third end portion (21) comprises:
vanes (19) longitudinally aligned with the second opening (4) and the elongate stator (11);
and/or directional vents at the second opening (4)

8. A device as claimed in claim 4 or 5, wherein the diameter of housing (2) reduces and the cross sectional area of elongate stator (11) increases from the third longitudinal limit (7) to the fourth longitudinal limit (8) in the third end portion (21);
wherein the rate of the cross-sectional area increases along the elongate stator (11)

9. A device as claimed in claim 4 or 5 comprising:
one or more rotors 1 of opposite chirality rotatable by one or more motors (25);
wherein one or more portions of housing (2) rotate independently of rotor (1) or duct (26) positioned on one or more opposite sides of housing (2) such that the first opening (3) and the second opening (4) are interchangeable to supply or exhaust fluid

10. A device as claimed in claim 4 or 5 comprising:
heat exchange components (28);
a first flow path from an exterior vent (30) to a second interior vent (32)
a second flow path from a first interior vent (33) to the second interior vent (32);
wherein the first flow path is open or partially open when the second flow path is closed and vice versa;
wherein the heat exchange components (28) are between the rotor (1) and the second interior vent (32)

11. A device as claimed in claim 4 or 5, the device comprising
two or more co-axial rotors (1);
a means to invert rotational direction of the two or more co-axial rotors 1;
wherein the means comprises bevel gears (35)

12. A device as claimed in claim 1, the rotor comprising
elongate first and second substantially helically shaped first portions (61) having a longitudinal axis (15), the second helically shaped first portion (61) having an opposite chirality to the first substantially helically shaped first portion (61);
at least two pairs of blades (16), wherein at least one first and one second blade extend from the elongate first and second substantially helically shaped first portions (61);
the first opening (3) defining the fluid intake substantially axially aligned with first end portions (13) of first and second substantially helically shaped first portions (61);
at least two second openings (4) defining a fluid outlet longitudinally offset from the first opening;
and at least two third end portions (21) comprising the second opening (4) defining a fluid outlet longitudinally offset from the first opening;

13. A device as claimed in claim 1, wherein the first opening (3) defines the fluid intake provided substantially axially aligned with the substantially helically shaped first and second portions (61 and 62);
wherein the surface area of housing (2) between lateral limits (9a, 9b) amounts to at least a fifth of the total surface area of the first and second end portions (13 and 14) of housing (2) and first opening (3)
wherein blade (16) is rotated by an external energy such as wind or water

14. A device as claimed in claim 13, wherein side (73) of opening (3) directs a fluid counter to the direction of blades (16) rotation to create a vortex (72) between housing (2) and blade (16).

15. A device as claimed in claim 13, the device comprising:
one or more baffles (35) in one or more blades (16) wherein blade (16) is concave;
a first gap (37) and an inner cylindrical wall (50) between blade (16) and axis (15);
a second gap (38) between one or more baffles (37) and the surface of blade (16) the third end portion (21) comprising a cavity (47) and a means (29) to capture a fluid

16. A device as claimed in claim 13, the device comprising:
ODGV (40) radiating partially or totally around the turbine;
wherein the one or more baffles (36) are longitudinally concave in the direction of blade (16)

17. A device as claimed in claims 12 and 15, the device comprising:
a first and second substantially helically shaped second portion (62);
wherein the first and second substantially helically shaped first portions (61) and the first and second substantially helically shaped second portions (62) direct a fluid towards the central portion between the first and second substantially helically shaped first portions (61);
wherein inner cylindrical wall (50) comprises a gap (75)

18. A device as claimed in claim 17, the device comprising:
one or more venturi tubes in the walls of the cavity (47) between one or more VWAT (57) to collect condensate (71)
wherein the venturi tube comprises a first opening (66) and a second smaller opening (67) connected by a first venturi tube housing (69)
wherein the condensate (71) collects in the second venturi tube housing (70)

19. A device as claimed in claim 18, wherein the one or more venturi tube housing (69) is hexagonal
